(19) United States
(12) Patent Application Publication
(10) Pub. No.: US 2017/0072231 A1
(43) Pub. Date: Mar. 16, 2017

(54) SELF-CONTAINED BREATHING APPARATUS EQUIPMENT

(71) Applicant: Dräger Safety AG & Co. KGaA, Lubeck (DE)

(72) Inventors: Conor Carr, Tynemouth (GB); David Cheesman, Bedlington (GB); James Docherty, Blyth (GB); David Bell, Blyth (GB)

(21) Appl. No.: 15/260,866

(22) Filed: Sep. 9, 2016

(30) Foreign Application Priority Data
Sep. 10, 2015 (GB) 1516077.3

(51) Int. Cl. A62B 9/00; A62B 9/02; A62B 7/02; A62B 25/00; A62B 9/04

(52) U.S. Cl. CPC A62B 9/006; A62B 25/00; A62B 9/04; A62B 7/02; A62B 9/02; A62B 9/003

(57) ABSTRACT

There is disclosed self-contained breathing apparatus equipment 20 comprising a harness 22, 62 comprising a structural member 26, 28, 64 for supporting or housing a cylinder of breathable gas 40. The equipment comprises a visual alert generator 54 comprising a light source 60, 76 mounted to the structural member, the visual alert generator having a plurality of display modes, a wireless receiver 50 arranged to receive telemetry data transmitted from a central control unit 16, and a control module 52 arranged to receive status data, the status data including the telemetry data. The control module 52 is arranged to control the display mode of the visual alert generator based on the received status data.

### CROSS-REFERENCE TO RELATED APPLICATIONS

The present application claims priority to GB1516077.3 filed on 10 Sep. 2015 which is hereby incorporated by reference in its entirety for any and all purposes.

### BACKGROUND

The invention relates to self-contained breathing apparatus equipment comprising a visual alert generator.

Self-contained breathing apparatus (SCBA) equipment is frequently used to supply clean breathable gas to persons working in hazardous environments. Self-contained breathing apparatus equipment typically comprises a harness which can be worn so that the wearer can easily carry the breathing apparatus equipment. Two known types of self-contained breathing apparatus are open-circuit breathing apparatus and closed-circuit breathing apparatus.

In open-circuit breathing apparatus, breathable gas is supplied to the wearer from a cylinder of compressed air. The compressed air cylinder may be mounted to a back frame or plate of a harness. In closed-circuit breathing apparatus (sometimes referred to as rebreathers) there is a breathing circuit having a breathing port, a counterlung (or breathing bag), a carbon dioxide absorber, such as a scrubber, and a cooler connected to form a loop. As the user inhales/exhales the air is recirculated within the breathing circuit. The scrubber acts to remove carbon dioxide, whilst the cooler reduces the temperature of the air. A cylinder of compressed oxygen is provided for replenishing the recirculated air with oxygen. The breathing apparatus components including the cylinder are typically housed within a case forming part of a harness which can be worn by the user. Open-circuit breathing apparatus is typically used by firefighters, for example, whilst closed-circuit breathing apparatus is typically used by rescue personnel working in mines, for example.

It is known to provide breathing apparatus equipment with sensors for sensing various conditions such as movement, gas pressure, temperature, and heart rate. The breathing apparatus equipment may also be provided with a monitoring unit which can monitor the various conditions, and which can generate an alert on a handheld device if required. For example, if the gas pressure drops below a threshold then the handheld device may generate an audible and/or a visual warning. However, in some cases, it may not be possible or appropriate to use an audible warning. Thus, if only a visual warning is displayed on the user's handheld device, this visual warning may go unnoticed for a relatively long period of time. This may present a safety hazard to the wearer.

It is therefore desirable to provide an improved arrangement that may help to improve the safety of the wearer to at least some extent.

### SUMMARY

According to an aspect there is provided self-contained breathing apparatus equipment, comprising: a harness comprising a wearable harness for carrying a vessel of breathable gas; a visual alert generator comprising a light source mounted to the harness, the visual alert generator having a plurality of display modes; a wireless receiver arranged to receive telemetry data transmitted from a central control unit; and a control module arranged to receive status data, the status data including the telemetry data; wherein the control module is further arranged to control the display mode of the visual alert generator based on the received status data. The term “harness” should be understood to mean carrying apparatus which can be worn by a user so that they can carry breathing apparatus components, including a vessel of breathable gas. The harness may comprise one or more straps allowing it to be worn by a wearer.

The harness may comprise a back portion. The harness may be arranged such that, when worn, the back portion is positioned on the wearer's back. The light source may be mounted to the back portion of the harness. The back portion may be one or more components or parts that, in use, are positioned on the wearer's back. For example, the back portion could include a back frame or plate, a structural member, a case, a casing member, a portion of a waist strap, or portions of one or more shoulder straps that are positioned on a user's back.

The harness may comprise a structural member for supporting or housing a vessel of breathable gas. The harness may be arranged such that, when worn, the structural member is positioned on the wearer's back. The light source may be mounted to the structural member. The structural member may be part of the back portion. The structural member may be a back member arranged to be positioned over a wearer's back. The back member may have an inwardly facing surface arranged to face the wearer's back, and an outwardly facing surface. The light source may be attached or mounted or adjacent to the outwardly facing surface. The structural member may have left and right side regions. At least one light source may be mounted to the left side region. At least one light source may be mounted to the right side region. The structural member may be substantially rectangular or cuboidal.

If the light source is mounted in a position in which, when the harness is worn it is positioned on a user's back, then the display mode being displayed by the visual alert generator can be observed by a team member or colleague, but not necessarily by the person themselves. This could be the case if the light source is mounted to a back portion, such as a rear section of a waist belt or a structural member (e.g. a back plate).

The status data received may also include breathing apparatus status data as well as telemetry data. The breathing apparatus status data may be locally generated at the breathing apparatus equipment, rather than being received from an external source such as the central control unit. The central control unit may be outside of a hazardous environment and may be remote from the breathing apparatus equipment. The vessel of breathable gas may be referred to as pressure vessel and could be a cylinder of breathable gas.

The light source may be mounted such that it is outwardly facing. The light source may be mounted such that when the harness is worn, the at least one light source is positioned over the wearer's back. The light source may be mounted such that when the harness is worn, the at least one light source is not directly viewable by the wearer. The visual alert generator may comprise a plurality of light sources mounted to harness (e.g. to the back portion and/or to the structural member). There may be a secondary visual alert generator comprising at least one light source.

The breathing apparatus equipment may further comprise a pressure transducer arranged to generate pressure data relating to the gas pressure within a part of the breathing circuit of the breathing apparatus. The status data may include the pressure data. The breathing circuit could be a closed or an open circuit. There may be a plurality of pressure sensors, each generating pressure data relating to the pressure within a different part of the breathing circuit.

The control module may be arranged to determine one or more status based on the received status data. The control module may be arranged to determine only a single status at any one time. The or each status may have a display mode associated with it. One of the display modes could be a “darkness” display mode in which no light sources are illuminated. The control module may be arranged to activate the display mode associated with the determined status. If plural status are determined, the control module may be arranged to activate the display mode associated with one of the determined status. The control module may be arranged to activate only the display mode associated with the status having the highest priority, if a plurality of status are determined from the received status data. Each status that the control module is capable of identifying or determining may have a priority associated with it.

The control module may be arranged to determine an evacuation status if the telemetry data of the received status data includes an evacuation message transmitted from the central control unit. The control module may be arranged to determine a normal operation status if the received status data is indicative of normal operation of the breathing apparatus. The control module may be arranged to determine a low gas pressure status if the pressure data of the received status data indicates that the gas pressure of the vessel of breathable gas is below a threshold. The control module may be arranged to determine a gas leak status if the pressure data of the received status data is indicative of a gas leak from the breathing circuit of the breathing apparatus. There may be other status that the control module is arranged to determine based on other data. For example, there could be a high heart rate status which could be identified from heart rate data, a high temperature status which could be identified from temperature data, a no movement status which could be identified from motion data.

There may be a pre-defined status set comprising a plurality of status which the control module is capable of determining. The control module may be arranged to determine one or more status from the pre-defined status set based on the received status data. The pre-defined status set may comprise an evacuation status and/or a normal operational status and/or a low gas pressure status and/or a gas leak status. Of course, other status could be included within the pre-defined status set.

Each display mode may be unique. This may mean that when a display mode is activated it is readily apparent what it is indicating. The visual alert generator may be arranged to display only a single display mode at any one time. Thus, only a single status may be able to be indicated at any one time.

The harness may comprise left and right shoulder straps coupled to the structural member. The shoulder straps may be adjustable. There may also be a waist belt which may be adjustable.

The breathing apparatus equipment may be closed-circuit breathing apparatus equipment. The harness may comprise a case forming the structural member. The case may protectively house and support breathing apparatus components including a vessel of breathable gas. The case may comprise first and second parts including a rear part and a front part. The rear part may be arranged to face the wearer's back and the front part may be arranged to face away from the wearer. The light source or sources may be mounted to the front part. There may be a first lighting strip mounted to the left side of the case and a second lighting strip mounted to the right side of the case. The lighting strips may each comprise one or more light sources.

The breathing apparatus equipment may be open-circuit breathing apparatus equipment. The harness may comprise a back plate or frame forming the structural member. The back plate or frame may be arranged to support a vessel of breathable gas. The back plate/frame may have an inner surface arranged to face the wearer's back and an outer surface arranged to face away from the wearer's back. The or each light source may be mounted or attached or adjacent to the outer surface.

There is also provided a breathing apparatus system comprising: a plurality of self-compressed breathing apparatus equipment sets, each in accordance with any statement herein; and a central control unit comprising a wireless transmitter arranged to transmit telemetry data.

According to another aspect there is provided a method of controlling a visual alert generator of self-contained breathing apparatus equipment, the visual alert generator comprising a light source and having a plurality of display modes, the method comprising: receiving telemetry data transmitted from a central control unit; receive status data including at least the telemetry data; controlling the display mode of the visual alert generator based on the received status data. The breathing apparatus equipment may be in accordance with any statement herein.

According to a further aspect there is provided an alert apparatus for use with breathing apparatus equipment for providing a visual alert to a user, the apparatus comprising: a visual alert generator having a plurality of display modes and comprising a light source; and a control module arranged to: receive status data; determine one or more status based on the received status data, each status having a display mode associated with it; and activate either (i) the display mode associated with the determined status if only a single status is determined, or (ii) only the display mode associated with the status having the highest priority if a plurality of status are determined.

The visual alert generator may be arranged to display only a single display mode at a time. Each display mode may be unique. The visual alert generator may comprise a plurality of light sources.

The control module may be arranged to receive status data including telemetry data transmitted from a central control unit. The control module may be arranged to determine an evacuation status if the telemetry data of the received status data includes an evacuation message transmitted from the central control unit.

The apparatus may further comprise a wireless receiver arranged to receive telemetry data transmitted from a central control unit.

The control module may be arranged to receive status data including breathing apparatus status data. The breathing apparatus status data may be generated by one or more sensors associated with the breathing apparatus equipment. The control module may be arranged to receive status data including pressure data relating to the gas pressure within a part of the breathing circuit of the breathing apparatus. The control module may be arranged to determine a low gas pressure status if the pressure data indicates that the gas pressure of the vessel of breathable gas is below a threshold. The control module may be arranged to determine a gas leak status if the pressure data is indicative of a gas leak from the breathing circuit of the breathing apparatus. The control module may be arranged to determine a normal operation status if the received status data is indicative of normal operation of the breathing apparatus.

There may be a pre-defined status set comprising a plurality of status which the control module is capable of determining. The control module may be arranged to determine one or more status from the pre-defined status set based on the received status data. The pre-defined status set may comprise an evacuation status and/or a normal operational status and/or a low gas pressure status and/or a gas leak status. Each of the plurality of status within the pre-defined status set may have a priority level associated with it.

According to another aspect there is provided breathing apparatus equipment comprising the alert apparatus in accordance with any statement herein. The breathing apparatus equipment may further comprise a wearable harness for carrying a vessel of breathable gas. The alert apparatus may be associated with or attached to the harness. The harness may comprise left and right shoulder straps. The breathing apparatus equipment may be self-contained breathing apparatus (SCBA) equipment.

According to yet a further aspect there is provided a method of providing a visual alert to a breathing apparatus equipment user, the apparatus comprising: receiving status data; determining one or more status based on the received status data, each status having a display mode associated with it; and controlling a visual alert generator having a plurality of display modes and comprising a light source by activating either (i) the display mode associated with the determined status if only a single status is determined, or (ii) only the display mode associated with the status having the highest priority if a plurality of status are determined.

The visual alert generator may be arranged to display only a single display mode at a time. Each display mode may be unique. The visual alert generator may comprise a plurality of light sources.

The method may further comprise receiving status data including telemetry data transmitted from a central control unit. The method may further comprise determining an evacuation status if the telemetry data of the received status data includes an evacuation message transmitted from the central control unit.

The method may further comprise receiving status data including breathing apparatus status data. The breathing apparatus status data may be generated by one or more sensors associated with the breathing apparatus equipment. The method may further comprise receiving status data including pressure data relating to the gas pressure within a part of the breathing circuit of the breathing apparatus. The method may further comprise determining a low gas pressure status if the pressure data indicates that the gas pressure of the vessel of breathable gas is below a threshold. The method may further comprise determining a gas leak status if the pressure data is indicative of a gas leak from the breathing circuit of the breathing apparatus. The method may further comprise determining a normal operation status if the received status data is indicative of normal operation of the breathing apparatus.

One or more status may be determined from a pre-defined status set. The pre-defined status set may comprise a plurality of status which are capable of being determined. The pre-defined status set may comprise an evacuation status and/or a normal operational status and/or a low gas pressure status and/or a gas leak status. Each of the plurality of status within the pre-defined status set may have a priority level associated with it.

The invention may comprise any combination of the features and/or limitations referred to herein, except combinations of such features as are mutually exclusive.

### BRIEF DESCRIPTION OF THE DRAWINGS

Embodiments of the invention will now be described, by way of example, with reference to the accompanying drawings, in which:

FIG. 1 schematically shows a team of emergency responders operating in a hazardous environment;

FIG. 2 schematically shows self-contained breathing apparatus equipment;

FIG. 3 schematically shows a harness of closed-circuit breathing apparatus equipment; and

FIG. 4 schematically shows a harness of open-circuit breathing apparatus equipment.

### DETAILED DESCRIPTION

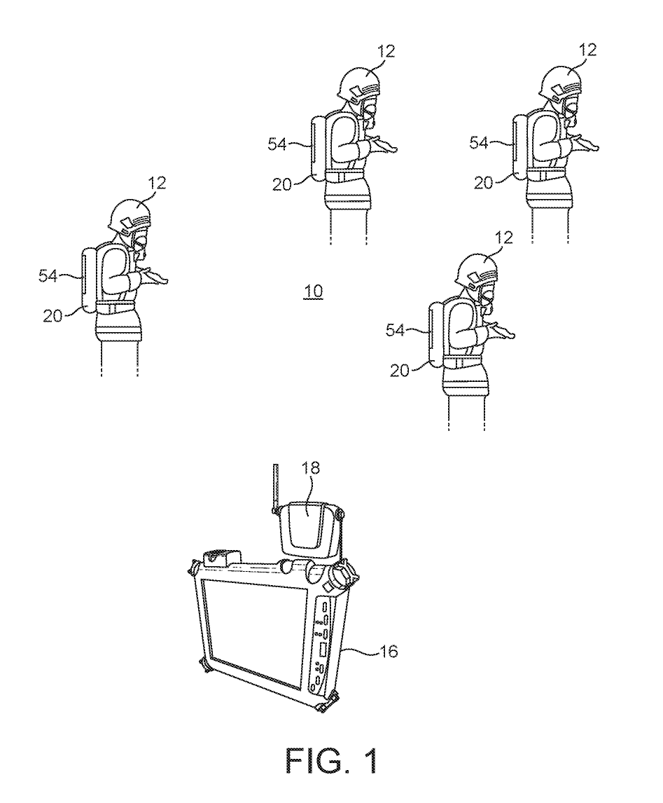

FIG. 1 shows a rescue team 10 of emergency responders 12 working in a hazardous environment. In this embodiment the hazardous environment is a mine, but it should be appreciated that the rescue team 10 could be working in any hazardous environment, such as a burning building. Each emergency responder 12 is provided with self-contained breathing apparatus (SCBA) equipment 20 for supplying the responder 12 with clean breathable gas from a vessel of breathable gas (i.e. a pressure vessel). The pressure vessel could be a cylinder of breathable gas, although other types of pressure vessel could be used. In this embodiment the self-contained breathing apparatus equipment 20 is closed-circuit breathing apparatus (CCBA) equipment which is sometimes referred to as a rebreather. However, the SCBA equipment could be any suitable type of breathing apparatus equipment such as open-circuit breathing apparatus equipment.

As will be described in detail below, the breathing apparatus equipment 20 is provided with a telemetry module comprising a wireless transceiver (not shown), and a central control unit 16 provided with a wireless transceiver 18 is located outside of the hazardous environment. The telemetry module of each breathing apparatus equipment set 20 can communicate with the central control unit 16 such that they can exchange data with one another. For example, the telemetry module may transmit to the central control unit 16 breathing apparatus status data such as the ambient temperature, gas pressure, heart rate and any other suitable data. This allows an operator (such as an entry control officer) to remotely monitor the status of the individual responders 12. The central control unit 16 can also transmit data to each telemetry module. For example, if the operator determines that it necessary to recall the team of emergency responders 12 out of the hazardous environment (e.g. out of the mine or building), an evacuation message can be sent to all of the telemetry modules. In some embodiments it may be possible to recall only some of the emergency responders, for example if the operator determines that a particular emergency responder's gas pressure is too low, or if their heart rate is too high.

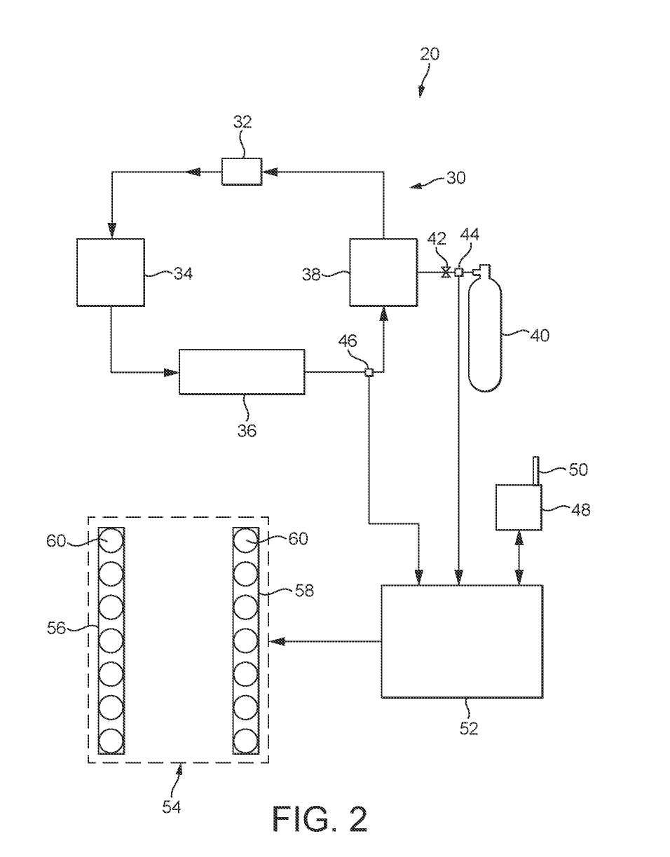

Referring now to FIG. 2, the closed-circuit breathing apparatus (CCBA) equipment 20 comprises a breathing circuit 30 which includes a breathing port 32, a carbon dioxide absorber 34, such as a scrubber, a counterlung 36 in the form of a variable volume breathing bag, and a cooler 38. An oxygen supply 40, for example a cylinder of compressed oxygen, is provided for supplying oxygen to the breathing circuit 30. The breathing port 32, carbon dioxide absorber 34, counterlung 36 and cooler 38 are arranged in fluid communication with each other so as to define a closed loop which extends from the breathing port 32 through the carbon dioxide absorber 34, counterlung 36 and cooler 38 before returning to the breathing port 32. First and second non-return valves (not shown) are disposed on opposite sides of the breathing port 32. The non-return valves are arranged such that air within the breathing circuit 30 flows in the anticlockwise direction (as shown in FIG. 2) only; that is, from the breathing port 32, through the carbon dioxide absorber 34, the counterlung 36 and the cooler 38 before returning to the breathing port 32. The oxygen supply 40 is in fluid communication with the cooler 38 via a valve 42. The valve arrangement 42 can be opened and closed so that the oxygen supply to the breathing circuit 30 can be turned on or off.

In normal operation, a user breathes through the breathing port 32. As the user exhales, air is forced through the first non-return valve, carbon dioxide absorber 34 and into the counterlung 36. The carbon dioxide absorber 34 absorbs a significant amount of the carbon dioxide which is present in the exhaled air. As the user inhales, air is drawn from the counterlung 36, through the cooler 38 and through the second non-return valve. As the air is drawn through the cooler 38 it mixes with the oxygen delivered to the cooler 38 by the oxygen supply 40. The oxygen supply 40 thus replenishes the air within the breathing circuit 30 with oxygen.

In this embodiment the breathing apparatus equipment 20 is provided with two pressure transducers (or sensors). A first pressure transducer 44 is provided in the breathing circuit upstream of the valve 42 such that it can monitor the gas pressure within the oxygen cylinder 40. A second pressure transducer 46 is provided in the breathing circuit 30 between the counterlung 36 and the cooler 38 such that it can monitor the gas pressure within the closed loop. The pressure transducers 44, 46 are arranged to generate an analogue (or digital) output representative of the gas pressure monitored.

As briefly discussed above, the breathing apparatus equipment 20 also comprises a telemetry module 48, having a wireless transceiver 50, which is arranged to communicate with the central control unit 16. The telemetry module 48 can wirelessly transmit breathing apparatus status data, such as the gas pressures monitored by the first and second pressure transducers 44, 46, to the central control unit 16 such that an operator can monitor the emergency responder 12. The central control unit 16 can also wirelessly transmit telemetry data to the telemetry module 48. The telemetry data may be any suitable type of data. For example, the telemetry data may contain an evacuation message instructing the emergency responder 12 to withdraw from the hazardous environment. Of course, the telemetry data could contain any suitable data such as directional instructions, the breathing apparatus status data of other emergency responders, or time to whistle (TTW), which in some embodiments could be calculated at the central control unit 16. In summary, the telemetry module 48 is arranged to wirelessly acquire or receive telemetry data from a central control unit 16.

The breathing apparatus equipment 20 further comprises a control module 52 which forms part of an alert apparatus for generating a visual alert. The control module 52 is connected to the first pressure sensor 44, the second pressure sensor 46 and the telemetry module 48. Thus, the control module 52 is arranged to receive status data, the status data comprising pressure data from the first pressure sensor 44, pressure data from the second pressure sensor 46, and telemetry data received by the telemetry module 48. The control module 52 is therefore arranged to receive both locally generated data (i.e. data generated on-board the breathing apparatus equipment) which may be referred to as breathing apparatus status data, and telemetry data transmitted to the breathing apparatus equipment from the central control unit 16. As will be explained in detail below, the control module 52 is configured to determine one or more status based on the received status data.

The breathing apparatus equipment 20 also comprises a visual alert generator 54, also forming part of the alert apparatus, which in this embodiment comprises two identical lighting arrays 56, 58. Each lighting array 56, 58 comprises a plurality of individual light sources 60 arranged side-by-side to form a lighting strip. In this embodiment, each light source 60 is an LED, and each lighting array 56, 58 comprises a mixture of red, blue, and yellow LEDs. The visual alert generator 54 has a plurality of different display modes (i.e. different lighting patterns/sequences), with each display mode being uniquely associated with a different status. The control module 52 is connected to the visual alert generator 54 and is configured to cause a particular display mode to be activated depending on the status determined. The visual alert generator 54, or the individual light sources 60, may be connected to the control module 52 by either a wired or wireless connection. This will be explained in detail below.

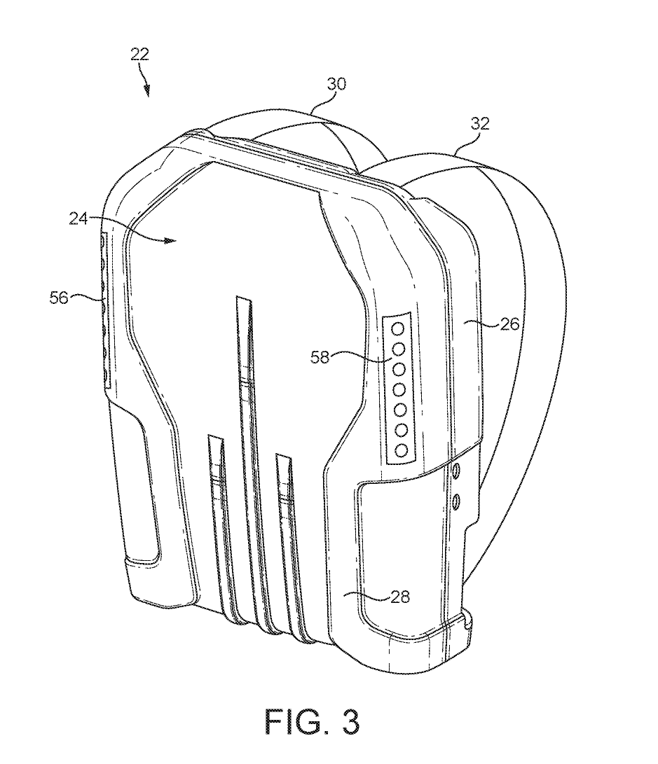

Referring now to FIG. 3, the closed-circuit breathing apparatus equipment 20 comprises a wearable harness 22 which allows the equipment to be worn and carried by a user. In this embodiment, the harness 22 comprises a substantially cuboidal case 24 having a front casing member 26 and a rear casing member 28. The front and rear casing members 26, 28 are detachably secured together to define an interior compartment. The case 24 protectively houses and secures the majority of the breathing apparatus components. In particular, the carbon dioxide absorber 34, the counterlung 36, the cooler 38 and the cylinder of oxygen 40 are housed and secured within the case 24. In this embodiment, the various electronic components including the pressure transducers 44, 46, the telemetry module 48 including the wireless receiver 50 and the control module 52 are also protectively housed within the case 24. The case 24 comprising the front and rear casing members 26, 28 are structural members that support and house the breathing apparatus components including the cylinder of breathable gas 40 (i.e. the oxygen cylinder). In this embodiment the casing members 26, 28 are substantially rigid and are made from a plastics material by injection moulding. However, in other embodiments the casing members 26, 28 could be made from a composite or from a light-weight metal. The harness also comprises left and right shoulder straps 30, 32 which are configured such that when the harness 22 is donned, the case 24 is worn or positioned on the wearer's back. When the harness 22 is worn, the outer surface of the rear casing member 26 is positioned against the wearer's back, and the outer surface of the front casing member 28 faces outwardly and away from the wearer.

The case 24 comprises left and right side regions that, in normal use, are substantially vertically extending. In this embodiment, a first lighting array 56 is mounted to the left side region of the case 24 and a second lighting array 58 is mounted to the right side region of the case 24. Specifically, a plurality of individual light sources 60 are mounted to the left side region of the front casing member 28, one above the other, such that a vertical lighting strip is formed. Similarly, a plurality of individual light sources 60 are mounted to the right side region of the front casing member 28, one above the other, such that a vertical lighting strip is formed. The individual light sources 60 are mounted such that face outwardly. The light sources 60 are mounted such that when the harness 22 is worn, they are not directly visible by the wearer.

As opposed to mounting the light sources 60 of the alert generator 54 to the structural casing member 28 (or other structural member), they could be mounted to another part of the harness 22. For example, they could me mounted to any back, or rear, region of the harness 22. In one example, the (or each) light source 60 could be mounted to the rear section of a waist belt or pad (not shown) that is positioned over the rear lumbar region of the user when the harness is worn. In another example, the light sources 60 could be mounted along the front faces of the shoulder straps 30, 32 to form lighting strips 56, 58 down the shoulder straps. It should be appreciated that the light sources 60 could be mounted or attached to any suitable region of the harness 22.

As explained above, the control module 52 is configured to analyse status data received and is capable of determining one or more status based on the received status data. In this embodiment, the control module 52 is capable of identifying from status data a normal operational status, a low gas pressure status, a gas leak status, and an evacuation status.

The control module 52 is configured to determine a “normal operation status” if the status data (including the pressure data and the telemetry data) is indicative that the breathing apparatus is operating as intended. In other words, the gas pressures are all within acceptable limits and the telemetry data does not contain any messages requiring action. The control module 52 is configured to determine a “low gas pressure status” if the pressure data from the first pressure transducer 44 indicates that the gas pressure within the oxygen cylinder 40 is below an acceptable limit (for example 55 bar). The control module 52 is configured to determine a “gas leak status” if the pressure data from the second pressure transducer 46 indicates that the gas pressure is too low and that therefore there may be a gas leak from the breathing circuit. The control module 52 is configured to determine an “evacuation status” if the telemetry data received from the central control unit 16 includes an evacuation message. As explained above, the telemetry data may include an evacuation message if the operator has initiated a recall of emergency responders 12.

In this embodiment the control module 52 is only capable of identifying four different status. However, it should be appreciated that it could be configured to identify other status such as a “high temperature status”, or a “high heart rate status”, or any other suitable status.

The control module 52 is configured so that at any one time it can determine that there are a plurality of status. For example, in use the control module 52 may determine that there is both a “low gas pressure status” and a “gas leak status”, or it may determine that there is a “low gas pressure status” and an “evacuation status”. Such a situation could possibly occur where there is a low gas pressure, and where the operator has initiated an evacuation by sending an evacuation message to the emergency responder 12. Clearly some status may be mutually exclusive (e.g. normal operation and low gas pressure).

In this embodiment, each status has a unique display mode (of the visual alert generator) associated with. The control module 52 is connected to the visual alert generator 54 and is configured such that it can activate the display mode associated with the determined status. However, in this embodiment the control module 52 is configured such that it can only cause the visual alert generator 54 to display a single display mode at any one time. Accordingly, each possible status has a priority (or level of importance) associated with it. Thus, if the control module 52 determines from the received status data that there are two or more status are present, it operates the visual alert generator 54 to activate (or display) only the display mode associated with the status having the highest priority. An example of the different status together with the associated priority levels and the associated display modes is shown in Table 1 below.

TABLE 1

| | PRIORITY | |
|---|---|---|
| STATUS | LEVEL | DISPLAY MODE |
| NORMAL OPERATION | 4 | 100 ms blue followed |
| | | by 1900 ms darkness |
| LOW GAS PRESSURE | 1 | 500 ms red followed |
| | | by 500 ms yellow |
| GAS LEAK | 2 | 500 ms red followed |
| | | by 500 ms darkness |
| EVACUATION | 3 | 500 ms yellow followed |
| | | by 500 ms darkness |

Priority 1 = highest,
Priority 4 = lowest

As an example, if the control module 52 determines from the received status data that there is only an evacuation status (i.e. the telemetry data contains an evacuation message) then the visual alert generator 54 is activated to utilise the display mode associated with that (i.e. 500 ms yellow followed by 500 ms darkness). However, if the control module 52 determines that there is an evacuation status and a low gas pressure status, then only the display mode associated with the low gas pressure status is activated (i.e. 500 ms red followed by 500 ms yellow) as it is deemed to be more important.

In this particular embodiment, due to the location of the light sources 60 of the visual alert generator 54, when a display mode is activated (e.g. the display mode associated with a low gas pressure status in which there is 500 ms red followed by 500 ms yellow), the flashing light sources 60 may not actually be directly observed or noticed by the wearer of the harness 22. That is, because the light sources 60 are on the structural member (i.e. the front casing 28) on the back of the wearer and are outwardly facing, they may be outside the peripheral vision of the wearer. Thus, in this embodiment, the visual alert generator 54 is not actually intended to provide a visual alert to the wearer themselves. Instead, due to the location of the light sources 60 which face away from the wearer, they are easily visible by other emergency responders 12 within the same team. This means another emergency responder can quickly see that the visual alert generator 24 of a team member's breathing apparatus equipment 20 is displaying a display mode indicative of a particular status. For example, a team member may quickly realise that a team member's breathing apparatus equipment 20 is displaying a display mode indicative of a gas leak, and they can immediately alert the team member to this. The visual alert generator 54 therefore allows an emergency responder 12 to be alerted to a problem by a team member, more quickly than if the alert was displayed on a small handheld gauge intended for the responder 12 themselves, for example. If the visual alert was only displayed on a small handheld gauge then this might go unnoticed for a relatively long period of time, for example if the emergency responder 12 was concentrating on carrying out a particular task. Accordingly, providing a visual alert generator 54 that is intended to be viewed by others within the team may provide a significant safety benefit.

Further, providing the light sources 60 of the visual alert generator 54 on the harness 22 provides a larger area over which the light sources 60 can be distributed. This allows more and/or larger light sources 60 to be used, so that, when activated, the display mode is highly visible. If the light sources 60 were provided only on a small handheld gauge, for example, then fewer and/or smaller light sources 60 would have to be used, which would make the display mode, when activated, less visible.

In the embodiment described above, the light sources 60 are mounted to lateral side regions of the structural member which is arranged to be positioned over the back of the wearer. However, the or each light source 60 could be positioned on the harness 22 in any suitable location. In some embodiments the light sources 60 may be attached to a part of the harness 22 such that the light sources 60 are positioned over the back of the wearer when the harness is worn. This may allow the light sources 60 to be viewed by other team members, but not necessarily by the wearer themselves. For example, there could be a single central light source mounted in the centre of the structural member such that it faces outwardly and away from the wearer. In another arrangement, there could be a single light beacon or light source mounted on a bottom edge of the structural member (e.g. the rear casing member 26) such that it projects a beam of light downwardly. In summary, the or each light source 60 is mounted to the structural member (which sits on the person's back) such that, when operated, they direct light outwards such that it can be viewed by a team member.

Although it has been described that the visual alert generator 54 can only display a single display mode at any one time, it should be appreciated that in other embodiments, if the control module 52 determines multiple status, the display modes associated with each of the status could all be displayed. For example, if the control module 52 determines that there is a “low gas pressure status” and an “evacuation status”, the visual alert generator 52 could be operated to display the display modes associated with both status. In one example, the left lighting array 56 could display the low gas pressure status, and the right lighting array 58 could display the evacuation status. Alternatively, the visual alert generator 54 could display one sequence of the display mode associated with the low gas pressure status, followed by one sequence of the display mode associated with the evacuation status.

The breathing apparatus equipment 20 could be provided with a secondary visual alert generator which may provide a visual display to the wearer themselves. For example, the breathing apparatus equipment 20 could be provided with a handheld gauge which comprises a secondary visual alert generator having one or more light sources. This secondary visual alert generator could also be connected to the control module 52 so that it displays the same alerts to the wearer.

In one embodiment, the visual alert generator 54 may only have two display modes. One of the display modes may simply be “darkness” in which none of the light sources 60 are illuminated. The other display mode could be any lighting pattern or sequence, and in a simple arrangement could be the constant illumination of a single light source.

It has been described that the control module 52 is configured to receive status data including pressure data and telemetry data, and is capable of identifying four different status. However, it should be appreciated that in other embodiments the control module 52 may only receive telemetry data, and therefore may not receive any locally generated breathing apparatus data such as pressure data. In such an embodiment, the control module 52 may analyse the telemetry data, and may control the visual alert generator 54 based on that data. For example, the control module 52 may be configured such that if the telemetry data contains an evacuation message, it illuminates the light sources 60 of the visual alert generator 54. At all other times, the visual alert generator 54 may provide no visual indication at all (i.e. a “darkness” display mode). It has been described that the telemetry data may contain an evacuation message and that this can be identified and displayed. However, in other embodiments the telemetry data could contain other useful data to be displayed. Thus, the control module 52 may be configured to recognize or identify such data and/or messages, and may be configured to control or operate the visual alert generator 54 in response thereto. Furthermore, as well as receiving local pressure data, the control module 52 may receive other locally generated breathing apparatus status data such as movement data (from a PASS/ADSU), temperature data, heart rate data, or any other suitable data. The control module 52 may be configured to cause the visual alert generator 54 to activate a display mode based on any of the data received.

Although it has been described that the visual alert generator 54 comprises a plurality of light sources 60 in the form of LEDs, in other arrangements other light sources 60 could be used. For example, in one embodiment the light source 60 could in fact be a LCD or LED screen mounted to the structural member such that it is outwardly facing away from the wearer.

In the embodiment described above there is no audible alerts provided and therefore the visual alert generator 54 is the only means for generating an alert. This may be necessary so that the breathing apparatus equipment complies with various industry standards such as the Escape and Rescue from Mines Regulations 1995. However, it will be appreciated that where appropriate, an audible alert generator could be provided.

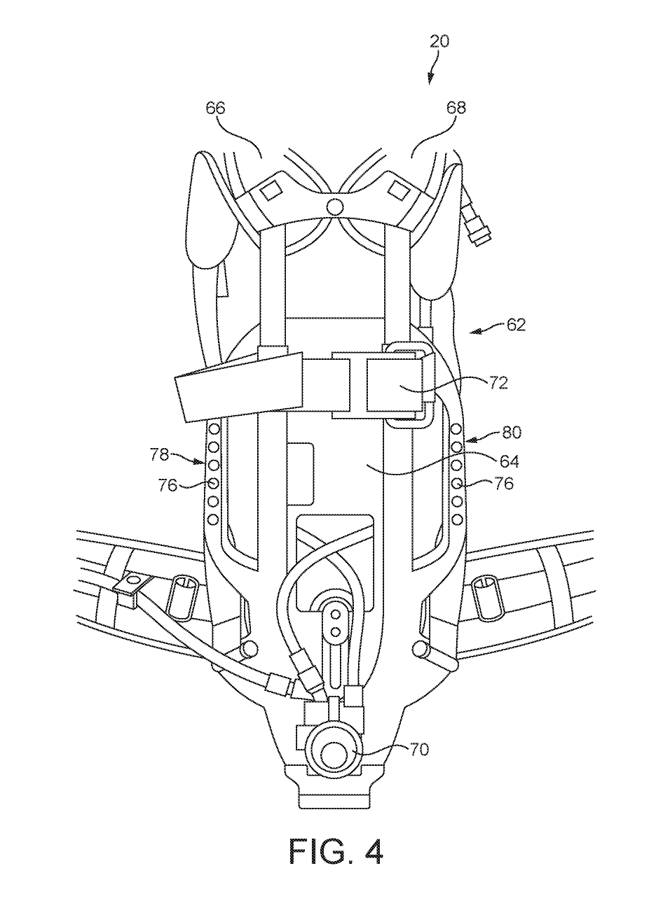

It has been described that the self-contained breathing apparatus equipment 20 is closed-circuit breathing apparatus equipment (i.e. a rebreather). However, as shown in FIG. 4, the breathing apparatus equipment 20 could be open circuit self-contained breathing apparatus equipment. As shown in FIG. 4, the open-circuit breathing apparatus equipment comprises a harness 62 having a structural member 64 in the form of a back plate or back frame which can support a cylinder of compressed air. Two shoulder straps 66, 68 are provided which allows the harness 62 to be worn by a user, such that the back plate/frame 64 sits over the user's back. A lower portion of the back plate/frame is provided with a regulator valve 70 to which the cylinder of gas can be attached. An upper region of the back plate/frame 64 is provided with a retaining strap 72 which can be used to secure the cylinder to the structural member 64. The electronic components such as the control module 52 and wireless receiver 50 may be mounted to the inner surface of the back plate/frame 64 and may be substantially as described above with respect to the first embodiment. In one embodiment, there may also be a pressure sensor (not shown) mounted such that it can monitor the pressure within the open breathing circuit (e.g. the pressure of the gas within the cylinder). As in the first embodiment, the visual alert generator comprises a plurality of light sources 76 arranged in two lighting strips 78, 80. In this embodiment, the light sources 76 are mounted to the outwardly facing surface of the back plate/frame 64, with one lighting strip 78 provided on a first side, and with the other lighting strip 80 provided on the second opposing side. Since the light sources 76 are located at the sides of the structural member 64, they are not occluded by the cylinder of breathable gas (when mounted) and thus can be viewed by other team members.

In a further embodiment (not shown) the alert apparatus for generating a visual alert may be incorporated into a hand-held monitoring device that is distinct from the harness, but that in use may be attached to a shoulder strap of a harness, for example. In such an embodiment, the light sources 60 may all be mounted to the monitoring device as opposed to being mounted to the harness 22. The alert apparatus incorporated into the monitoring device may be similar to that described above. In such an arrangement the control module is arranged to receive status data and determine one or more status (e.g. evacuation status or low gas pressure status) based on the received status data. If the control module determines multiple status, then it causes the visual alert generator (i.e. the light sources mounted to the monitoring device) to display the display mode associated with the status having the highest priority. For example, as described above, if the control module determines that there is an evacuation status and a low gas pressure status, then the display mode associated with the low gas pressure status is activated as it is deemed to be more important. Activating only a single display mode at any one time may be advantageous as it may make it easier for the user quickly determine what action to take. If multiple status are displayed at once then, depending on the circumstances, it may be more confusing to the user. The hand-held monitoring device described could be used with or without breathing apparatus equipment.

For the avoidance of doubt, the present application extends to the subject-matter described in the following numbered paragraphs (referred to as “Para” or “Paras”):
1. Self-contained breathing apparatus equipment, comprising:
   a wearable harness for carrying a vessel of breathable gas;
   a visual alert generator comprising a light source mounted to the harness, the visual alert generator having a plurality of display modes;
   a wireless receiver arranged to receive telemetry data transmitted from a central control unit; and
   a control module arranged to receive status data, the status data including the telemetry data;
   wherein the control module is further arranged to control the display mode of the visual alert generator based on the received status data.
2. Self-contained breathing apparatus equipment according to Para 1, wherein the harness comprises a back portion, and wherein the harness is arranged such that, when worn, the back portion is positioned on the wearer's back; and
   wherein the light source is mounted to the back portion of the harness.
3. Self-contained breathing apparatus equipment according to Para 1 or 2, wherein the harness comprises a structural member for supporting or housing a vessel of breathable gas, and wherein the harness is arranged such that, when worn, the structural member is positioned on the wearer's back; and
   wherein the light source is mounted to the structural member.
4. Self-contained breathing apparatus equipment according to Para 3, wherein the structural member has left and right side regions, and wherein at least one light source is mounted to the left side region and wherein at least one light source is mounted to the right side region.
5. Self-contained breathing apparatus equipment according to any preceding Para, wherein the light source is mounted such that it is outwardly facing.
6. Self-contained breathing apparatus equipment according to any preceding Para, wherein the light source is mounted such that, when the harness is worn, the light source is positioned over the wearer's back.
7. Self-contained breathing apparatus equipment according to any preceding Para, wherein the light source is mounted such that when the harness is worn, the at least one light source is not directly viewable by the wearer.
8. Self-contained breathing apparatus equipment according to any preceding Para, wherein the visual alert generator comprises a plurality of light sources.
9. Self-contained breathing apparatus equipment according to any preceding Para, wherein the harness comprises left and right shoulder straps coupled to the structural member.
10. Self-contained breathing apparatus equipment according to any preceding Para, further comprising a pressure transducer arranged to generate pressure data relating to the gas pressure within a part of the breathing circuit of the breathing apparatus, wherein the status data includes the pressure data.
11. Self-contained breathing apparatus equipment according to any preceding Para, wherein the control module is arranged to determine one or more status based on the received status data.
12. Self-contained breathing apparatus equipment according to Para 11, wherein each status has a display mode associated with it.
13. Self-contained breathing apparatus equipment according to Para 12, wherein the control module is arranged to activate the display mode associated with the determined status or the display mode associated with one of the determined status.
14. Self-contained breathing apparatus equipment according to Para 13, wherein the control module is arranged to activate the display mode associated with the status having the highest priority, if a plurality of status are determined from the received status data.
15. Self-contained breathing apparatus according to any of Paras 11-14, wherein the control module is arranged to determine an evacuation status if the telemetry data of the received status data includes an evacuation message transmitted from the central control unit.
16. Self-contained breathing apparatus according to any of Paras 11-15, wherein the control module is arranged to determine a normal operation status if the received status data is indicative of normal operation of the breathing apparatus.
17. Self-contained breathing apparatus according to any of Paras 11-16 when appended to Para 2, wherein the control module is arranged to determine a low gas pressure status if the pressure data of the received status data indicates that the gas pressure of the vessel of breathable gas is below a threshold.
18. Self-contained breathing apparatus according to any of Paras 11-17 when appended to Para 10, wherein the control module is arranged to determine a gas leak status if the pressure data of the received status data is indicative of a gas leak from the breathing circuit of the breathing apparatus.
19. Self-contained breathing apparatus equipment according to any of Paras 11-18, wherein there is a pre-defined status set comprising a plurality of status which the control module is capable of determining, and wherein the control module is arranged to determine one or more status from the pre-defined status set based on the received status data.
20. Self-contained breathing apparatus equipment according to Para 19, wherein the pre-defined status set comprises an evacuation status and/or a normal operational status and/or a low gas pressure status and/or a gas leak status.
21. Self-contained breathing apparatus equipment according to any preceding Para, wherein each display mode is unique.
22. Self-contained breathing apparatus equipment according to any preceding Para, wherein the visual alert generator is arranged to display only a single display mode.
23. Self-contained breathing apparatus equipment according to any preceding Para, wherein the breathing apparatus equipment is closed-circuit breathing apparatus equipment, and wherein the harness comprises a case forming the structural member.
24. Self-contained breathing apparatus equipment according to any of Paras 1-22, wherein the breathing apparatus equipment is open-circuit breathing apparatus equipment, and wherein the harness comprises a back plate or frame forming the structural member.
25. A breathing apparatus system comprising:
   a plurality of self-compressed breathing apparatus equipment sets, each in accordance with any of Paras 1-24; and
   a central control unit comprising a wireless transmitter arranged to transmit telemetry data.
26. An alert apparatus for use with breathing apparatus equipment for providing a visual alert to a user, the apparatus comprising:
a visual alert generator having a plurality of display modes and comprising a light source; and
   a control module arranged to:
      receive status data;
      determine one or more status based on the received status data, each status having a display mode associated with it; and
      activate either (i) the display mode associated with the determined status if only a single status is determined, or (ii) the display mode associated with the status having the highest priority if a plurality of status are determined.
27. An alert apparatus according to Para 26, wherein the visual alert generator is arranged to display only a single display mode at a time.
28. An alert apparatus according to Para 26 or 27, wherein each display mode is unique.
29. An alert apparatus according to any of Paras 26-28, wherein the visual alert generator comprises a plurality of light sources.
30. An alert apparatus according to any of Paras 26-29, wherein the control module is arranged to receive status data including telemetry data transmitted from a central control unit.
31. An alert apparatus according to Para 30, wherein the control module is arranged to determine an evacuation status if the telemetry data of the received status data includes an evacuation message transmitted from the central control unit.
32. An alert apparatus according to Para 30 or 31, further comprising a wireless receiver arranged to receive telemetry data transmitted from a central control unit.
33. An alert apparatus according to any of Paras 27-32, wherein the control module is arranged to receive status data including breathing apparatus status data.
34. An alert apparatus according to Para 33, wherein the breathing apparatus status data is generated by one or more sensors associated with the breathing apparatus equipment.
35. An alert apparatus according to any of Paras 26-34, wherein the control module is arranged to receive status data including pressure data relating to the gas pressure within a part of the breathing circuit of the breathing apparatus.
36. An alert apparatus according to Para 35, wherein the control module is arranged to determine a low gas pressure status if the pressure data indicates that the gas pressure of the vessel of breathable gas is below a threshold.
37. An alert apparatus according to Para 35 or 36, wherein the control module is arranged to determine a gas leak status if the pressure data is indicative of a gas leak from the breathing circuit of the breathing apparatus.
38. An alert apparatus according to any of Paras 26-37, wherein the control module is arranged to determine a normal operation status if the received status data is indicative of normal operation of the breathing apparatus.
39. An alert apparatus according to any of Paras 26-38, wherein there is a pre-defined status set comprising a plurality of status which the control module is capable of determining, and wherein the control module is arranged to determine one or more status from the pre-defined status set based on the received status data.
40. An alert apparatus according to Para 39, wherein the pre-defined status set comprises an evacuation status and/or a normal operational status and/or a low gas pressure status and/or a gas leak status.
41. An alert apparatus according to Para 39 or 40, wherein each of the plurality of status within the pre-defined status set has a priority level associated with it.
42. Breathing apparatus equipment comprising the alert apparatus in accordance with any of Paras 26-41.
43. Breathing apparatus equipment according to Para 42, further comprising a wearable harness for carrying a vessel of breathable gas, wherein the alert apparatus is associated with or attached to the harness.
44. Breathing apparatus equipment according to Para 43, wherein the harness comprises left and right shoulder straps.
45. A method of providing a visual alert to a breathing apparatus equipment user, the apparatus comprising:
   receiving status data;
   determining one or more status based on the received status data, each status having a display mode associated with it; and
   controlling a visual alert generator having a plurality of display modes and comprising a light source by activating either (i) the display mode associated with the determined status if only a single status is determined, or (ii) the display mode associated with the status having the highest priority if a plurality of status are determined.
46. A method according to Para 45, wherein the visual alert generator is arranged to display only a single display mode at a time.
47. A method according to Para 45 or 46, wherein each display mode is unique.
48. A method according to any of Paras 45-47, wherein the visual alert generator comprises a plurality of light sources.
49. A method according to any of Paras 45-48, further comprising receiving status data including telemetry data transmitted from a central control unit.
50. A method according to Para 49, further comprising determining an evacuation status if the telemetry data of the received status data includes an evacuation message transmitted from the central control unit.
51. A method according to any of Paras 45-50, further comprising receiving status data including breathing apparatus status data.
52. A method according to Para 51, wherein the breathing apparatus status data is generated by one or more sensors associated with the breathing apparatus equipment.
53. A method according to any of Paras 45-52, further comprising receiving status data including pressure data relating to the gas pressure within a part of the breathing circuit of the breathing apparatus.
54. A method according to Para 53, further comprising determining a low gas pressure status if the pressure data indicates that the gas pressure of the vessel of breathable gas is below a threshold.
55. A method according to Para 52 or 53, further comprising determining a gas leak status if the pressure data is indicative of a gas leak from the breathing circuit of the breathing apparatus.
56. A method according to any of Paras 45-55, further comprising determining a normal operation status if the received status data is indicative of normal operation of the breathing apparatus.
57. A method according to any of Paras 45-56, wherein one or more status is determined from a pre-defined status set, the pre-defined status set comprising a plurality of status which are capable of being determined.
58. A method according to Para 57, wherein the pre-defined status set comprises an evacuation status and/or a normal operational status and/or a low gas pressure status and/or a gas leak status.
59. A method according to Para 57 or 58, wherein each of the plurality of status within the pre-defined status set has a priority level associated with it.

We claim:

1. Self-contained breathing apparatus equipment, comprising:
a wearable harness for carrying a vessel of breathable gas;
a visual alert generator comprising a light source mounted to the harness, the visual alert generator having a plurality of display modes;
a wireless receiver arranged to receive telemetry data transmitted from a central control unit; and
a control module arranged to receive status data, the status data including the telemetry data;
wherein the control module is further arranged to control the display mode of the visual alert generator based on the received status data.

2. Self-contained breathing apparatus equipment according to claim 1, wherein the harness comprises a back portion, and wherein the harness is arranged such that, when worn, the back portion is positioned on the wearer's back; and
wherein the light source is mounted to the back portion of the harness.

3. Self-contained breathing apparatus equipment according to claim 1, wherein the harness comprises a structural member for supporting or housing a vessel of breathable gas, and wherein the harness is arranged such that, when worn, the structural member is positioned on the wearer's back; and
wherein the light source is mounted to the structural member.

4. Self-contained breathing apparatus equipment according to claim 3, wherein the structural member has left and right side regions, and wherein at least one light source is mounted to the left side region and wherein at least one light source is mounted to the right side region.

5. Self-contained breathing apparatus equipment according to claim 1, wherein the light source is mounted such that it is outwardly facing.

6. Self-contained breathing apparatus equipment according to claim 1, wherein the light source is mounted such that, when the harness is worn, the light source is positioned over the wearer's back.

7. Self-contained breathing apparatus equipment according to claim 1, wherein the light source is mounted such that when the harness is worn, the at least one light source is not directly viewable by the wearer.

8. Self-contained breathing apparatus equipment according to claim 1, further comprising a pressure transducer arranged to generate pressure data relating to the gas pressure within a part of the breathing circuit of the breathing apparatus, wherein the status data includes the pressure data.

9. Self-contained breathing apparatus equipment according to claim 1, wherein the control module is arranged to determine one or more status based on the received status data.

10. Self-contained breathing apparatus equipment according to claim 9, wherein each status has a display mode associated with it and wherein the control module is arranged to activate the display mode associated with the determined status or the display mode associated with one of the determined status.

11. Self-contained breathing apparatus equipment according to claim 10, wherein the control module is arranged to activate the display mode associated with the status having the highest priority, if a plurality of status are determined from the received status data.

12. Self-contained breathing apparatus according to claim 9, wherein the control module is arranged to determine an evacuation status if the telemetry data of the received status data includes an evacuation message transmitted from the central control unit.

13. Self-contained breathing apparatus equipment according to claim 9, wherein the control module is arranged to determine a normal operation status if the received status data is indicative of normal operation of the breathing apparatus.

14. Self-contained breathing apparatus equipment according to claim 9 when appended to claim 8, wherein the control module is arranged to determine a low gas pressure status if the pressure data of the received status data indicates that the gas pressure of the vessel of breathable gas is below a threshold.

15. Self-contained breathing apparatus equipment according to claim 9 when appended to claim 8, wherein the control module is arranged to determine a gas leak status if the pressure data of the received status data is indicative of a gas leak from the breathing circuit of the breathing apparatus.

16. Self-contained breathing apparatus equipment according to claim 9, wherein there is a pre-defined status set comprising a plurality of status which the control module is capable of determining, and wherein the control module is arranged to determine one or more status from the pre-defined status set based on the received status data.

17. Self-contained breathing apparatus equipment according to claim 16, wherein the pre-defined status set comprises an evacuation status and/or a normal operational status and/or a low gas pressure status and/or a gas leak status.

18. Self-contained breathing apparatus equipment according to claim 1, wherein the visual alert generator is arranged to display only a single display mode.

19. An alert apparatus for use with breathing apparatus equipment for providing a visual alert to a user, the apparatus comprising:
a visual alert generator having a plurality of display modes and comprising a light source; and
a control module arranged to:
receive status data;
determine one or more status based on the received status data, each status having a display mode associated with it; and
activate either (i) the display mode associated with the determined status if only a single status is determined, or (ii) the display mode associated with the status having the highest priority if a plurality of status are determined.

20. A method of providing a visual alert to a breathing apparatus equipment user, the apparatus comprising:
receiving status data;
determining one or more status based on the received status data, each status having a display mode associated with it; and
controlling a visual alert generator having a plurality of display modes and comprising a light source by activating either (i) the display mode associated with the determined status if only a single status is determined, or (ii) the display mode associated with the status having the highest priority if a plurality of status are determined.
